(19) United States
(12) Patent Application Publication
(10) Pub. No.: US 2004/0237959 A1
(43) Pub. Date: Dec. 2, 2004

(54) Variable heat conductivity pan

(76) Inventor: Linda Ashley, Hopkinton, MA (US)

Correspondence Address: LINDA ASHLEY, 31 ALEXANDER ROAD, HOPKINTON, MA, 01748, US

(21) Appl. No.: 10/452,544

(22) Filed: Jun. 2, 2003

(51) Int. Cl. A47J 27/02

(52) U.S. Cl. 126/390.1

(57) ABSTRACT

A cooking utensil constructed with two or more layers. Differing rates of thermal expansion occur between the layers during cooking. Contact points convert the differing horizontal expansion into vertical movement, displacing the layers. The vertical displacement causes an insulating air gap to form at an engineered temperature. The air gap protects the food from burning at high temperature. The absence of the air gap at lower temperature increases efficiency of cooking and heating at non-burning temperatures.

### BACKGROUND OF THE INVENTION

1. Field of Invention

This invention relates to a culinary device for cooking food.

2. Description of Background and Relevant Information

Numerous techniques are known in the arts for preventing the burning of food during cooking in a pot or pan used on a heating element or flame. The most common technique is to improved heat distribution within the pan by using heat conductivity layers (U.S. Pat. No. 4,204,607). Another technique involves use of insulating layers of air (U.S. Pat. No. 4,489,852) or materials (U.S. Pat. No. 1,245,670) in the bottom of the pan. A less common but interesting technique involves the use of working fluids or vapor stage heat transfer (U.S. Pat. No. 3,815,575).

Significant problems exist with the working fluids technique. Manufacture of the sealed vessel is expensive. Fluids are heavy and slow to heat. A severe overheating condition could rupture the vessel, releasing hot liquid or vapor under pressure, possibly burning bystanders. The air insulation technique is effective, but not without disadvantages. Insulation lengthens the cooking process. Insulation can moderating heat transfer too much, reducing desirable browning effects. These disadvantages are discussed in the art (U.S. Pat. No. 5,845,805).

The use of heat conductivity layers in pots and pans is effective and widely used. Heat conductivity layers do require more raw material than standard pans, increasing manufacturing and shipping costs. The thermal inertia of the conductivity layer can also increase pre-heating time and reduce the responsiveness of the pan temperature to changes in cooking heat. Heat conductivity layers distribute heat more easily, but don't moderate heat conductivity under high heat conditions to reduce the risk of burning the food.

Another design involves the use of two plates on the bottom of the pan that are made of metals with dissimilar coefficients of expansion and that are bound together on the edges (U.S. Pat. No. 4,363,316). In this design, heat expansion causes buckling in the material layers introducing an air gap under a heat condition. A disadvantage of this design is that the buckling begins immediately upon heating, introducing an insulating factor prior to the pan reaching normal operating temperature. The buckling mechanism is also hard to control and can result in bowing of the pan and other avoidable stresses. Many pan designs specifically focus on reducing the warping of a pan after multiple heat cycles, and this design immediately exacerbates these problems.

### BRIEF DESCRIPTION OF THE INVENTION

The invention is an improved pan for the preparation of food over a heat source such as a gas flame or electric resistance. The pan consists of two or more layers of metal that are attached, but with some slack so as to allow movement due to thermal expansion. The separate layers expand horizontally at different rates during cooking due to differing coefficients of expansion or a thermal gradient. Ramp like contact points between the pan's layers convert the differential lateral expansion into vertical movement of pan's upper layer. This vertical movement forms an insulating air gap. The insulating air gap reduces the chance of burning the food being cooked. Movement of the pans at the contact points limits the total stress between the layers.

The pan can be designed so that in the initial low temperature condition, no air gap exists between the bottom layers and an insulating air gap forms on the sides of the vessel, speeding initial heating. After a critical design temperature is reached, contact between the layers occurs and an insulating air gap forms between the bottom layers. The insulating air gap on the sides of the vessel disappear helping to dissipate excess heat. The pan thus actively transitions between two different states depending on heating conditions.

Tuning of the temperature at which the bottom air gap forms may be accomplished in several ways. Important design points include selection of metals with different coefficients of expansion and initial distance between contact points. The size of the insulating air gap formed may be controlled by the difference in expansion coefficients of the layers and the shape of contact points.

### OBJECTS AND ADVANTAGES

It is an object of the invention to create a cooking utensil with a variable heat conductivity profile to reduce the chance of burning food.

It is an object of the invention to initially deliver high heat conductivity to speed cooking of the food.

It is an object of the invention to be able to engineer the temperature when the utensil changes from high heat conductivity to low.

It is an object of the invention to minimize the introduction of additional bending stresses in the utensil's layers to minimize the risk of warping of the utensil.

It is an object of the invention to provide variable control of heat conductivity by passive means.

It is an object of the invention to be produced by simple techniques, with loose tolerances and minimal use of raw materials.

It is an object of the invention to preserve the safety of the user.

### BRIEF DESCRIPITION OF THE DRAWINGS

FIG. 1—Bottom layer expansion pan, room temperature

FIG. 2—Bottom layer expansion pan, transition temperature

FIG. 3—Bottom layer expansion pan, high temperature

FIG. 4—Bottom layer expansion pan, inner contact form

FIG. 5—Graph of temperature versus thermal conductivity

FIG. 6—Top layer expansion pan, room temperature

FIG. 7—Top layer expansion pan, transition temperature

FIG. 8—Top layer expansion pan, high temperature

FIG. 9—Internal pan layer with suction relief air channels

FIG. 10—Baking sheet in low temperature configuration

FIG. 11—Baking sheet in high temperature configuration

FIG. 12—Cupcake tray in low temperature configuration

FIG. 13—Cupcake tray in high temperature configuration

### REFERENCE NUMERALS IN DRAWINGS

| | |
|---|---|
| 1 | Handle |
| 2 | Bottom expansion pan upper layer |
| 4 | Bottom expansion pan lower layer |
| 6 | Inner contact pan upper layer |
| 8 | Inner contact pan lower layer |
| 10 | Top expansion pan upper layer |
| 12 | Top expansion pan lower layer |
| 13 | Baking sheet edge upper layer |
| 14 | Baking sheet edge lower layer |
| 15 | Cup cake tray |
| 16 | Cup cake upper layer |
| 17 | Cup cake lower layer |

### DETAILED DESCRIPTION OF THE PREFERRED EMBODIMENT

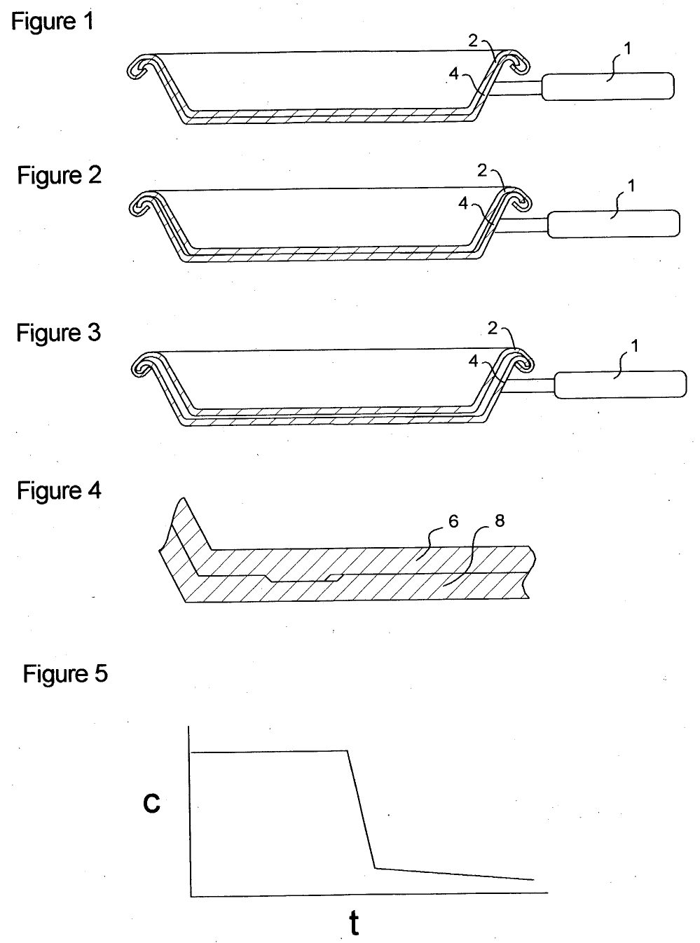

An embodiment of the present invention at room temperature is shown in FIG. 1. The pan consists of upper 2 and lower 4 layers with ramp like contact points along the circumference of the pans. Initially an air gap exists between the contact points to allow for a period of expansion where no contact will occur. FIG. 2 shows the same invention heated to near the designed transition temperature. The bottom layer has expanded more quickly than the top layer due to a higher coefficient of expansion or proximity to the heat source. The contact points are now touching. The transition temperature should be designed near the upper level food temperature desired. A suitable point is 150 degrees Celsius, under the temperature when many oils will begin to smoke.

FIG. 3 shows the pan layers after heating above the transition temperature has occurred. Due to increasing thermal expansion of the bottom pan, the contact points have been forced together and have slipped along each other. Contact point movement has wedged the pan layers apart, forming an insulating air layer between the pans. The air gap will slow heating of food in the inner pan and reduce the chance that burning of the food occurs. FIG. 4 shows an alternate form of the bottom expansion pan where inner contact points are constructed by forming ridges and troughs into the upper 6 and lower 8 pan layers.

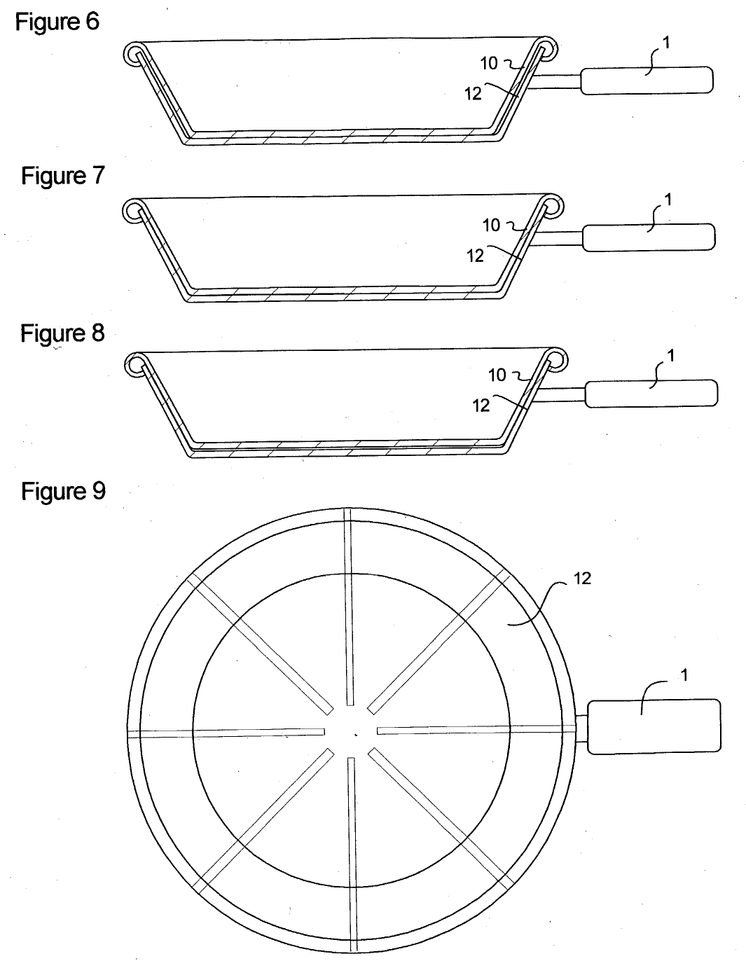

FIG. 5 shows a graph of the thermal conductivity between the pan layers varying with temperature. Initially, conductivity is high, but transitions rapidly to a lower value once the ramp portions of the contact points move across each other forming an air gap. FIGS. 6, 7 and 8 show a pan where the upper layer 10 has a higher coefficient of expansion than the lower layer 12. As the pan is heated, greater expansion of the upper layer occurs wedging apart the layers of the pan. FIG. 9 shows a lower pan layer with embossed air channels to admit air and relieve the tendency for a suction to form between pan layers. Holes may also be used for the same purpose.

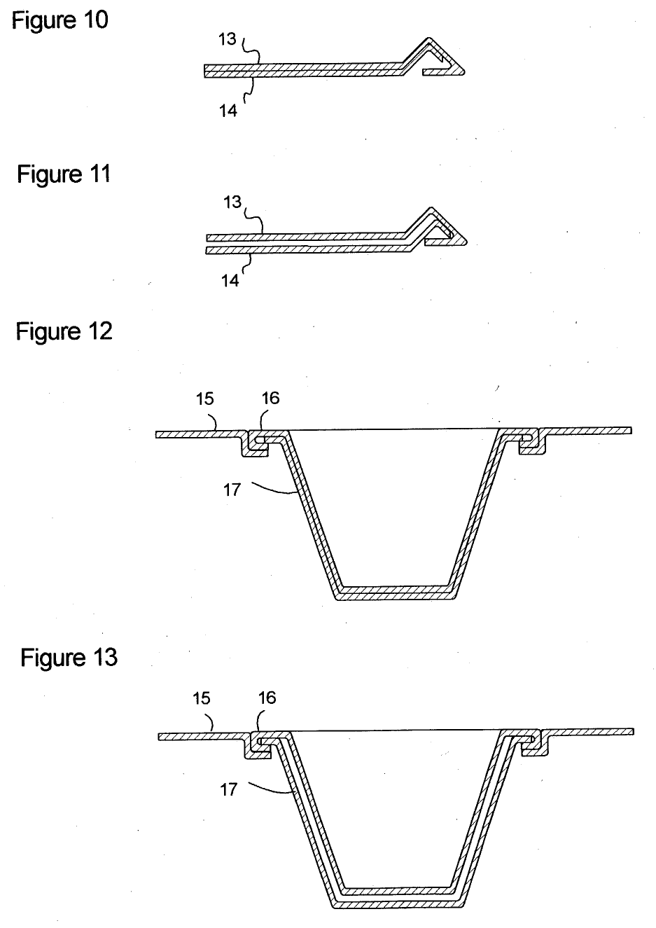

FIG. 10 shows the edge structure of a flat baking pan constructed so as to yield the variable air gap provided by the invention. FIG. 10 shows the low temperature configuration, and FIG. 11 shows the high temperature configuration after expansion of the lower layer and formation of the air gap. FIG. 12 shows a cup cake tray constructed to introduce a variable air gap, in the low temperature configuration. In the cup cake tray expansion of the sidewalls may also be used to introduce an air gap. FIG. 13 shows the cup cake tray in high temperature configuration, where the lower layer has expanded away from the inner layer introducing an air gap. Expansion of the lower layer is not hindered by the design of the attachment to the upper layer.

Tuning of the temperature when the air gap is created can be accomplished by adjusting the initial slack distance between contact points. The initial slack can be sized according to the differing thermal expansion rates of the pan layers. For example, assume a pan with a top layer was constructed of S42000 stainless steel (expansion coefficient 10×10⁻⁶ meters/meter/degree Celsius) and the bottom layer of aluminum (expansion coefficient 23×10⁻⁶). The target air gap formation temperature is 310 Fahrenheit/154 Celsius. Room temperature is assumed to be 75 F/24 C. The coefficient difference multiplied by the distance between the contact points and the design heat differential yields the initial contact point slack. For example, (23−10)×10⁻⁶×0.3 meters×130 Celsius temperature difference=0.5 millimeters initial contact point separation at 24C.

A thermal differential between the pan layers due to the heat source below and cold food above can also induce a difference in expansion between the layers. Empirical experimentation will yield the correct compensation factors for various heat sources and food situations. The size of the air gap that forms can be controlled by the difference in thermal expansion rates between the layers and also the slope of the contact structure. Greater expansion rate differentials and greater contact slope will yield a larger air gap.

A further improvement to the construction of the utensil could include using heat conductive materials between the two pans, such as the high temperature silicon grease or thermal pads used in electronics heat sinks. This layer would increase the thermal conductivity of the pan layers for initial heating. High temperature lubricant on the contact points would also minimize the buckling stresses induced in the pan layers. A compressible but high temperature material such as fiberglass strands could be used to push the pans back together upon cooling and minimize the feeling of looseness between the pan layers. Standard finishing improvements such as a non-stick surface on the inside of the pan and anodized aluminum or polished stainless steel outer layers would further increase the marketability of the utensil.

### SUMMARY: RAMIFICATIONS AND SCOPE

Accordingly, significant improvements in cooking utensil performance can result from use of the invention. The invention allows a cooking utensil to rapidly transition from high to low thermal conductivity to reduce the chances of food burning, without reducing the efficiency of lower temperature cooking. The invention avoids complex, active heat controls and is simple to manufacture. The invention avoids use of large quantities of raw materials in order to distribute heat. The invention avoids inclusion of liquids or gases that could cause an unsafe condition under high heat conditions.

Although the descriptions above contain many specificities, these should not be construed as limiting the scope of the invention, but merely as providing illustrations of the some of the presently preferred embodiments of the invention. Thus the scope of the invention should be determined by the appended claims and their legal equivalents, rather than by the examples given.

What is claimed is:

1. A food cooking utensil consisting of a plurality of layers of material, the improvement consisting of contact points between the layers designed to convert horizontal thermal expansion into vertical movement in order to form an insulating air gap as the layers interact during thermal expansion.

2. The layers of claim 1 wherein said layers are constructed of material with similar expansion rates, and heating differentials between layers cause differential thermal expansion.

3. The layers of claim 1 wherein said layers are constructed of material with dissimilar expansion rates, and uppermost layer having the larger expansion rate.

4. The layers of claim 1 wherein said layers are constructed of material with dissimilar expansion rates, and lowermost layer having the larger expansion rate.

5. The cooking utensil of claim 1 wherein said layers are constructed of metal.

6. The cooking utensil of claim 1 wherein said layers consist of aluminum and low thermal expansion coefficient stainless steel.

7. The cooking utensil of claim 1 wherein the interior of the vessel is lined with non-stick coating.

8. The layers of claim 1 wherein said layers consist of thin sheet for use in baking.

9. The layers of claim 1 wherein thermal conductivity between said layers is improved by use of a thermal conductivity agent.

10. The layers of claim 1 wherein said layers are embossed with a pattern or perforated with holes to relieve suction.

11. A food cooking utensil consisting of a plurality of layers of material, the improvement consisting of the use of differential thermal expansion in the horizontal and vertical dimensions between the layers to form an insulating air gap as the layers expand.

12. The layers of claim 11 wherein said layers consist of thin sheet for use in baking.

13. The layers of claim 11 wherein said layers are connected together with slack to accommodate expansion between the layers.

14. The cooking utensil of claim 11 wherein the interior of the vessel is lined with non-stick coating.

15. The layers of claim 11 wherein said layers are embossed with a pattern or perforated with holes to relieve suction.
